(19) United States
(12) Patent Application Publication
(10) Pub. No.: US 2026/0042686 A1
(43) Pub. Date: Feb. 12, 2026

(54) TREATMENT SYSTEM WITH SEPARATOR TANK

(71) Applicant: HYAXIOM, INC., East Hartford, CT (US)

(72) Inventors: Sean Foley, Windsor Locks, CT (US); Franz Koberg, Bethlehem, PA (US)

(21) Appl. No.: 18/796,816

(22) Filed: Aug. 7, 2024

(51) Int. Cl. C02F 1/461

(52) U.S. Cl. CPC C02F 1/46104; C02F 2201/005; C02F 2201/46115; C02F 2201/46145

(57) ABSTRACT

A system includes at least one electrochemical device including a proton exchange membrane situated between an anode and a cathode. An oxygen separator is fluidly connected to an inlet to the anode and a hydrogen separator is fluidly connected to an outlet from the cathode. A separator tank fluidly interconnects an outlet from the hydrogen separator to an inlet to the oxygen separator.

### BACKGROUND

This disclosure relates to a water treatment system associated with one or more electrolyzers.

Electrolyzers are known electrochemical devices that may be configured to convert electricity and water into hydrogen and oxygen. Electrolyzers comprising proton exchange membrane water electrolyzer (PEMWE) cell assemblies provide a variety of challenges. In implementations, a PEM is situated between an anode catalyst layer and a cathode catalyst layer. The PEM forms a barrier between the anode and cathode; however, the PEM is not water proof. Despite an existing pressure gradient, there may be a significant net-crossover of water from the anode to the cathode. Water is to be separated from a cathode stream and fed-back to an anode loop in a recycling process. This recycling loop may carry dissolved hydrogen towards the oxygen side, which should be minimized.

### SUMMARY

In one example implementation, a system comprises: at least one electrochemical device including a proton exchange membrane situated between an anode and a cathode; an oxygen separator fluidly connected to an inlet to the anode; a hydrogen separator fluidly connected to an outlet from the cathode; and a separator tank fluidly interconnecting an outlet from the hydrogen separator to an inlet to the oxygen separator.

In a further non-limiting implementation of any system, the hydrogen separator is adapted to operate at a first pressure and the separator tank is adapted to operate at a second pressure that is lower than the first pressure.

In a further non-limiting implementation of any system, the separator tank includes a vent valve.

In a further non-limiting implementation of any system, the separator tank includes a drain valve.

In a further non-limiting implementation of any system, a pressure reducing valve is downstream of an outlet from the hydrogen separator and upstream of an inlet into the separator tank.

In a further non-limiting implementation of any system, a pump is fluidly connected to an outlet from the oxygen separator and fluidly connected to the inlet to the anode.

In a further non-limiting implementation of any system, the outlet from the hydrogen separator is adapted to communicate water and dissolved hydrogen, and wherein the hydrogen separator is adapted to communicate a second outlet for hydrogen gas.

In a further non-limiting implementation of any system, the separator tank is adapted to vent hydrogen gas via a vent valve, and wherein an outlet from the separator tank is operable to provide recycled water to the inlet to the oxygen separator.

In a further non-limiting implementation of any system, the inlet to the oxygen separator comprises a first inlet, and wherein an outlet from the anode is adapted to communicate water and oxygen to a second inlet to the oxygen separator, and wherein a first outlet from the oxygen separator is adapted to provide water to the inlet to the anode, and the oxygen separator includes a second outlet adapted to communicate oxygen gas.

In a further non-limiting implementation of any system, the separator tank is entirely located below a minimum water level of the oxygen separator.

In one example implementation, a system comprises: at least one electrochemical device including: an anode having an inlet and an outlet; a cathode having an outlet; and a proton exchange membrane situated between the anode and the cathode; an oxygen separator having at least one inlet and at least one outlet, the at least one outlet of the oxygen separator being fluidly connected to the inlet to the anode; a hydrogen separator having an inlet and at least one outlet, the inlet of the hydrogen separator being fluidly connected to the outlet from the cathode; and a separator tank having an inlet and at least one outlet, the inlet to the separator tank being fluidly connected to the at least one outlet from the hydrogen separator and the at least one outlet of the separator tank being fluidly connected to the at least one inlet to the oxygen separator.

In a further non-limiting implementation of any system, the at least one outlet from the hydrogen separator is adapted to communicate water and dissolved hydrogen, and wherein the hydrogen separator includes a second outlet adapted to communicate hydrogen gas.

In a further non-limiting implementation of any system, the inlet to the separator tank is adapted to receive the water and dissolved hydrogen from the hydrogen separator, and wherein the at least one outlet from the separator tank is adapted to provide recycled water to the at least one inlet to the oxygen separator, and wherein the separator tank includes a second outlet that is adapted to vent hydrogen gas via a vent valve.

In a further non-limiting implementation of any system, the at least one inlet to the oxygen separator is adapted to receive the recycled water from the separator tank, and wherein the outlet from the anode is adapted to communicate water and oxygen to a second inlet to the oxygen separator, and wherein the at least one outlet from the oxygen separator is adapted to provide water to the inlet to the anode, and wherein the oxygen separator includes a second outlet adapted to communicate oxygen gas.

In a further non-limiting implementation of any system, the hydrogen separator is adapted to operate at a first pressure and the separator tank is adapted to operate at a second pressure that is lower than the first pressure.

In a further non-limiting implementation of any system, the separator tank includes a vent valve and a drain valve, and including: a pressure reducing valve downstream of the at least one outlet from the hydrogen separator and upstream of the inlet into the separator tank; and/or a pump fluidly connected to the at least one outlet from the oxygen separator and fluidly connected to the inlet to the anode.

In a further non-limiting implementation of any system, the separator tank is entirely located below a minimum water level of the oxygen separator.

In one example implementation, a method comprises: providing at least one electrochemical device including a proton exchange membrane situated between an anode and a cathode; fluidly connecting an oxygen separator to an inlet to the anode; fluidly connecting a hydrogen separator to an outlet from the cathode; fluidly interconnecting an outlet from the hydrogen separator to an inlet to the oxygen separator with a separator tank; and venting hydrogen from the separator tank and forwarding degassed water to the oxygen separator.

In a further non-limiting implementation of any method, the method includes operating the hydrogen separator at a first pressure and operating the separator tank at a second pressure that is lower than the first pressure.

In a further non-limiting implementation of any method, the method includes locating the separator tank entirely below a minimum water level of the oxygen separator.

The present disclosure may include any one or more of the individual features disclosed above and/or below alone or in any combination thereof.

Various features and advantages of at least one disclosed example embodiment will become apparent to those skilled in the art from the following detailed description. The drawing that accompanies the detailed description can be briefly described as follows.

### BRIEF DESCRIPTION OF THE DRAWING

FIG. 1 schematically illustrates a selected portion of an electrochemical device.

FIG. 2 is a schematic representation of a water treatment system for the electrochemical device, which includes a separator tank associated with a water feedback line.

Like reference numbers and designations in the various drawings indicate like elements.

### DETAILED DESCRIPTION

The subject disclosure relates to a water treatment system associated with one or more electrochemical devices such as a PEMWE.

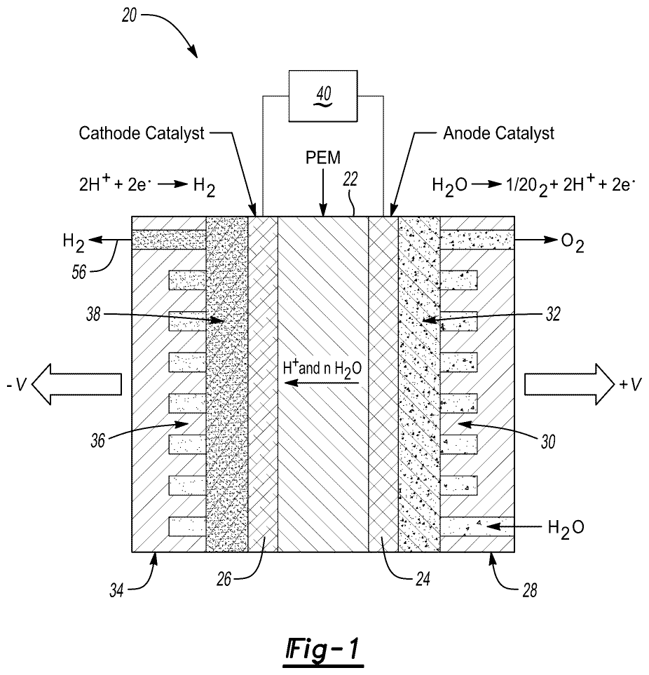

FIG. 1 schematically discloses an electrochemical device (e.g., assembly) 20 according to an implementation. The electrochemical device 20 may be an electrolyzer assembly such as a PEMWE. The operation of an electrolyzer assembly is known and it should be understood that the PEMWE is just one example of an electrolyzer, other types could also be used. The teachings disclosed herein may be utilized with other electrochemical devices, such as a fuel cell. The electrochemical device 20 may incorporate any of the features disclosed herein. In the implementation of FIG. 1, a PEM 22 is situated between an anode catalyst layer 24 and a cathode catalyst layer 26. An anode portion 28 includes an anode flowfield component 30 and an anode transport layer 32. A cathode portion 34 includes a cathode flowfield component 36 and a cathode transport layer 38. FIG. 1 shows oxygen O₂ being generated on and removed from the anode 28 and hydrogen H₂ generated on and removed from a cathode 34. A power source 40 may be operable to supply current to facilitate an electrolysis reaction for producing hydrogen and oxygen, for example.

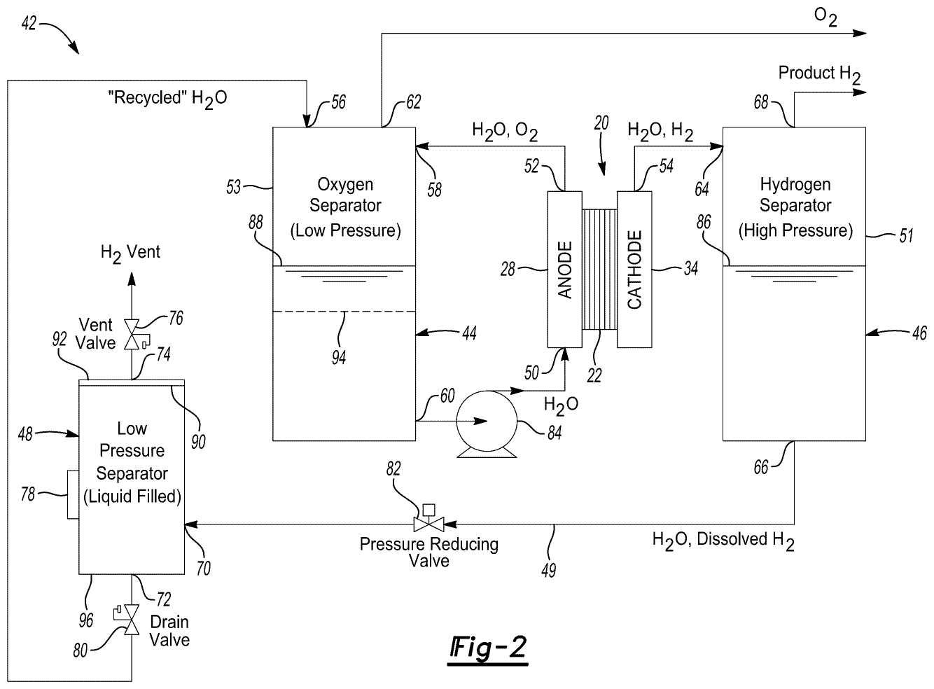

FIG. 2 discloses an implementation of a water treatment system 42 to supply water to an arrangement of electrochemical devices 20. In implementations, the water treatment system 42 includes one or more electrochemical devices 20, an oxygen separator 44, a hydrogen separator 46, and a separator tank 48. In implementations, the separator tank 48 is added into a water feedback line 49 between a tank 51 for the hydrogen separator 46 associated with the cathode 34, e.g., a high pressure tank, and a tank 53 for the oxygen separator 44 associated with the anode 28 e.g., a low pressure tank. In this configuration, the separator tank 48 tank allows recycled water to depressurize, degas, and remove some dissolved hydrogen before being returned to the oxygen separator 44. As such, the hydrogen load in the recycle stream may be minimized or otherwise reduced.

In implementations, the electrochemical device 20 comprises a plurality of proton exchange membrane water electrolyzers, e.g., stacks of electrochemical devices.

In implementations, the anode 28 has an inlet 50 and an outlet 52.

In implementations, the cathode 34 receives water and hydrogen from the PEM 22 (FIG. 1) and has an outlet 54.

In implementations, the oxygen separator 44 has a first inlet 56, a second inlet 58, a first outlet 60, and a second outlet 62.

In implementations, the hydrogen separator 46 has an inlet 64, a first outlet 66, and a second outlet 68.

In implementations, the separator tank 48 has an inlet 70, a first outlet 72, and a second outlet 74.

In implementations, the first outlet 60 of the oxygen separator 44 is fluidly connected to the inlet 50 to the anode 28.

In implementations, the inlet 64 of the hydrogen separator is fluidly connected to the outlet 54 from the cathode 34.

In implementations, the inlet 70 to the separator tank 48 is fluidly connected to the first outlet 66 from the hydrogen separator 46.

In implementations, the first outlet 72 of the separator tank 48 is fluidly connected to the first inlet 56 to the oxygen separator 44.

In implementations, the first outlet 66 from the hydrogen separator 46 may communicate water and dissolved hydrogen.

In implementations, the second outlet 68 from the hydrogen separator 46 may communicate hydrogen gas.

In implementations, the inlet 70 to the separator tank 48 receives the water and dissolved hydrogen from the hydrogen separator 46, and the outlet 72 from the separator tank 48 provides recycled water to the first inlet 56 to the oxygen separator 44.

In implementations, the second outlet 74 from the separator tank 48 vents hydrogen gas via a vent valve 76.

In implementations, the first inlet 56 to the oxygen separator 44 receives the recycled water from the separator tank 48, and the outlet 52 from the anode 28 may communicate water and oxygen that is provided to the second inlet 58 to the oxygen separator 44.

In implementations, the first outlet 60 from the oxygen separator 44 provides water to the inlet 50 to the anode 28.

In implementations, the second outlet 62 from the oxygen separator 44 may communicate oxygen gas.

In implementations, the hydrogen separator 46 is at a first pressure and the separator tank 48 is at a second pressure that is lower than the first pressure during operation. In implementations, the hydrogen separator 46 is also at a higher pressure than the oxygen separator 44. The pressure differential allows the recycled water to depressurize, degas, and remove some of the dissolved hydrogen before returning to the oxygen separator 44.

In implementations, the hydrogen separator 46 may operate at approximately a pressure of 30 bar; however, other operational pressures could also be used.

In implementations, the pressure level into the separator tank 48 may operate at approximately an ambient pressure.

In implementations, the separator tank 48 may be equipped with a heater 78 to facilitate degassing of hydrogen.

In implementations, the separator tank 48 includes the vent valve 76 to vent hydrogen gas.

In implementations, the separator tank 48 includes a drain valve 80.

In implementations, a pressure reducing valve 82 is downstream of the first outlet 66 from the hydrogen separator 46, and upstream of the inlet 70 into the separator tank 48.

In implementations, a pump 84 is fluidly connected to the first outlet 60 from the oxygen separator 44, and is fluidly connected to the inlet 50 to the anode 28. In one example, the pump 84 comprises a centrifugal pump; however, other types of pumps could also be used.

In implementations, the hydrogen separator tank 51 has a water level 86, the oxygen separator tank 53 has a water level 88, and the separator tank has a water level 90.

In implementations, the separator tank 48 is always filled with water such that the water level 90 is close to, or nearly at a top 92 of, the tank 48.

In implementations, as the water level 90 goes down, the vent valve 76 opens to release hydrogen and increase the water level.

In implementations, the separator tank 48 comprises a vertical cylinder with the vent valve 76, e.g., hydrogen vent, at the top 92 and the water drain valve 80 at a bottom 96 of the tank 48. In implementations, both valves 76, 80 may be realized as floating ball valves or other similar types of valves.

In implementations, the separator tank 48 is entirely located below a minimum water level 94 of the oxygen separator 44, e.g., a larger water reservoir. This causes separator tank 48 to always be filled with water, as hydrogen gas is pushed into the vent valve 76. The vent valve 76 prevents flooding the vent and allows a build-up of a minimum required pressure in the separator tank 48 to forward the liquid into the larger reservoir, e.g., the tank 53 for the oxygen separator 44. The drain valve 80 will typically stay open and may only serve as a mechanical gas barrier for unexpected operation conditions (e.g., when the separator tank feed stream turns into a pressurized hydrogen gas). In implementations, the separator tank 48 is sized to provide a reasonable retention time for an expected flow rate. In implementations, maintaining the separator 48 to be completely filled with water minimizes the potential volume of hydrogen H₂ that could be delivered into the oxygen separator 53 in the “unexpected operation” condition.

In implementations, the water treatment system 42 allows the water to degas and vents-off gas into an appropriate vent, while also draining/forwarding degassed water against a backpressure into a larger reservoir. Additionally, the degas tank should remain oxygen free to avoid a deflagration condition, and the reduced hydrogen loading of the recycled water stream, reduces the risk of deflagration inside the tank associated with the anode 28. Also, there is no oxygen backflow into the separator tank 48, which reduces the deflagration inside the separator tank 48.

In implementations, the separator tank 48 may automatically be set to a minimum required pressure, which maximizes the degas success. Thus, there is no need for extra pumps to forward water into the larger reservoir tank.

In implementations, the separator tank 48 provides a physical barrier to prevent gaseous hydrogen crossover into the anode tank due to the drain valve 80, and provides a physical to prevent flooding the exhaust vent due to vent valve 76. As such, water is not pushed out of the separator tank 48 into the exhaust vent 76 and hydrogen is not forwarded into the tank 53, e.g. the oxygen separator 44.

The preceding description is illustrative rather than limiting in nature. Variations and modifications to the disclosed examples may become apparent to those skilled in the art that do not necessarily depart from the essence of this invention.

What is claimed:

1. A system comprising:
at least one electrochemical device including a proton exchange membrane situated between an anode and a cathode;
an oxygen separator fluidly connected to an inlet to the anode;
a hydrogen separator fluidly connected to an outlet from the cathode; and
a separator tank fluidly interconnecting an outlet from the hydrogen separator to an inlet to the oxygen separator.

2. The system as recited in claim 1, wherein the hydrogen separator is adapted to operate at a first pressure and the separator tank is adapted to operate at a second pressure that is lower than the first pressure.

3. The system as recited in claim 1, wherein the separator tank includes a vent valve.

4. The system as recited in claim 1, wherein the separator tank includes a drain valve.

5. The system as recited in claim 1, including a pressure reducing valve downstream of an outlet from the hydrogen separator and upstream of an inlet into the separator tank.

6. The system as recited in claim 1, including a pump fluidly connected to an outlet from the oxygen separator and fluidly connected to the inlet to the anode.

7. The system as recited in claim 1, wherein the outlet from the hydrogen separator is adapted to communicate water and dissolved hydrogen, and wherein the hydrogen separator is adapted to communicate a second outlet for hydrogen gas.

8. The system as recited in claim 7, wherein the separator tank is adapted to vent hydrogen gas via a vent valve, and wherein an outlet from the separator tank is operable to provide recycled water to the inlet to the oxygen separator.

9. The system as recited in claim 8, wherein the inlet to the oxygen separator comprises a first inlet, and wherein an outlet from the anode is adapted to communicate water and oxygen to a second inlet to the oxygen separator, and wherein a first outlet from the oxygen separator is adapted to provide water to the inlet to the anode, and the oxygen separator includes a second outlet adapted to communicate oxygen gas.

10. The system as recited in claim 1, wherein the separator tank is entirely located below a minimum water level of the oxygen separator.

11. A system comprising:
at least one electrochemical device including:
an anode having an inlet and an outlet;
a cathode having an outlet; and
a proton exchange membrane situated between the anode and the cathode;
an oxygen separator having at least one inlet and at least one outlet, the at least one outlet of the oxygen separator being fluidly connected to the inlet to the anode;
a hydrogen separator having an inlet and at least one outlet, the inlet of the hydrogen separator being fluidly connected to the outlet from the cathode; and
a separator tank having an inlet and at least one outlet, the inlet to the separator tank being fluidly connected to the at least one outlet from the hydrogen separator and the at least one outlet of the separator tank being fluidly connected to the at least one inlet to the oxygen separator.

12. The system as recited in claim 11, wherein the at least one outlet from the hydrogen separator is adapted to communicate water and dissolved hydrogen, and wherein the hydrogen separator includes a second outlet adapted to communicate hydrogen gas.

13. The system as recited in claim 12, wherein the inlet to the separator tank is adapted to receive the water and dissolved hydrogen from the hydrogen separator, and wherein the at least one outlet from the separator tank is adapted to provide recycled water to the at least one inlet to the oxygen separator, and wherein the separator tank includes a second outlet that is adapted to vent hydrogen gas via a vent valve.

14. The system as recited in claim 13, wherein the at least one inlet to the oxygen separator is adapted to receive the recycled water from the separator tank, and wherein the outlet from the anode is adapted to communicate water and oxygen to a second inlet to the oxygen separator, and wherein the at least one outlet from the oxygen separator is adapted to provide water to the inlet to the anode, and wherein the oxygen separator includes a second outlet adapted to communicate oxygen gas.

15. The system as recited in claim 11, wherein the hydrogen separator is adapted to operate at a first pressure and the separator tank is adapted to operate at a second pressure that is lower than the first pressure.

16. The system as recited in claim 11, wherein the separator tank includes a vent valve and a drain valve, and including:
a pressure reducing valve downstream of the at least one outlet from the hydrogen separator and upstream of the inlet into the separator tank; and/or
a pump fluidly connected to the at least one outlet from the oxygen separator and fluidly connected to the inlet to the anode.

17. The system as recited in claim 11, wherein the separator tank is entirely located below a minimum water level of the oxygen separator.

18. A method comprising:
providing at least one electrochemical device including a proton exchange membrane situated between an anode and a cathode;
fluidly connecting an oxygen separator to an inlet to the anode;
fluidly connecting a hydrogen separator to an outlet from the cathode;
fluidly interconnecting an outlet from the hydrogen separator to an inlet to the oxygen separator with a separator tank; and
venting hydrogen from the separator tank and forwarding degassed water to the oxygen separator.

19. The method as recited in claim 18, including operating the hydrogen separator at a first pressure and operating the separator tank at a second pressure that is lower than the first pressure.

20. The method as recited in claim 18, including locating the separator tank entirely below a minimum water level of the oxygen separator.
